(19) United States
(12) Patent Application Publication
(10) Pub. No.: US 2010/0012499 A1
(43) Pub. Date: Jan. 21, 2010

(54) FUEL CELL CHARGER

(76) Inventors: Yu Zhou, Dublin, CA (US); Farshid Arman, Lafayette, CA (US); Jean Gastinel, Portola Valley, CA (US)

Correspondence Address: MORRISON & FOERSTER LLP, 755 PAGE MILL RD, PALO ALTO, CA, 94304-1018, US

(21) Appl. No.: 12/302,166

(22) PCT Filed: Jun. 1, 2007
(86) PCT No.: PCT/US07/12984

§ 371 Date: Jun. 5, 2009

Related U.S. Application Data
(60) Provisional application No. 60/810,425, filed on Jun. 1, 2006.

(51) Int. Cl. C25B 1/04; H01M 4/04

(52) U.S. Cl. 205/59; 204/277; 205/57

(57) ABSTRACT

A method and apparatus is described for recharging a fuel used to produce hydrogen for a hydrogen consuming device. The fuel can be NaBH₄ which forms NaBO₂ upon reacting with H₂O to produce hydrogen. The NaBO₂ is converted to NaBH₄ through a series of coupled chemical reactions which include reacting NaBO₂ with a metal and hydrogen to produce NaBH₄ and oxidized metal. The oxidized metal can then be recycled using an electrolytic process which converts the oxidized metal to metal and oxygen. The apparatus includes a transport mechanism for removing the spent fuel such as NaBO₂ from the hydrogen consuming device to the charger and delivering the recharged fuel, such as NaBH₄, back to the hydrogen consuming device.

### CROSS-REFERENCE TO RELATED APPLICATIONS

This application claims the benefit of U.S. provisional application Ser. No. 60/810,425, filed Jun. 1, 2006, which is hereby incorporated by reference in its entirety as if put forth in full below.

### BACKGROUND OF THE INVENTION

Conventional chemical batteries have a number of disadvantages. One disadvantage is that they have limited capacity with respect to their energy density. This capacity limitation impacts the ability of current chemical batteries to operate under continuous load. Even rechargeable batteries are often limited to 4-5 hours of continuous usage. Another disadvantage is that they have a relatively short shelf-life, often less than 3 to 5 years. A final disadvantage is that many modern batteries include harsh or toxic chemicals that pose long-term environmental hazards.

Fuel cell devices can deliver electrical energy without some of the disadvantages of conventional batteries. However, many fuel cell configurations have drawbacks of their own. For instance, some designs utilize a fuel supply that is external to the device. The proton exchange membrane fuel cell (PEMFC) uses oxygen and hydrogen. The oxygen is typically taken from the air but the hydrogen is typically supplied as a clean gas from an external hydrogen supply, such as a storage tank or other external source. Although such fuel cells may be acceptable for providing electrical energy to stationary loads, these configurations are not currently considered appropriate for movable or portable loads found in consumer electronic devices. Additionally, the very presence of an external fuel supply renders them impractical (perhaps even unsafe) for use in applications involving remote devices, such as safety devices or alarm sensors situated within a building.

Recent developments have eliminated the need for an external fuel source by providing an internal fuel which stores hydrogen and releases the hydrogen via a chemical reaction. Such fuels include solid materials such as Al or NaBH₄, which in the presence of water react to produce hydrogen.

One of the problems with using fuel cells containing a solid fuel source is the inability to recharge the depleted solid fuel. The following describes devices and methods for recharging the solid fuel used to generate hydrogen in a hydrogen consuming device such as a hydrogen fuel cell.

### BRIEF SUMMARY OF THE INVENTION

Disclosed herein are the methods and apparatus of the invention. This invention is not to be regarded as limited to any particular section disclosed herein.

A method of recharging an M(BH₄)_{y} fuel by converting M(BO₂)_{y} to M(BH₄)_{y}, wherein M(BO₂)_{y} is a byproduct of the reaction of M(BH₄)_{y} fuel with H₂O to produce hydrogen for a hydrogen consuming device and wherein M is cationic metal ion and y is an integer having the same value as the charge on M is described. The method comprising reacting the M(BO₂)_{y} with Al and hydrogen to produce M(BH₄)_{y} and Al₂O₃. The method further comprises supplying the Al by electrolytically converting Al₂O₃ to Al and oxygen. The method further comprises supplying the hydrogen from a hydrogen supply, wherein the hydrogen supply is an electrolytic cell which converts water into hydrogen and oxygen. The method further comprises obtaining the M(BO₂)_{y} from a fuel cartridge of the hydrogen consuming device. The method further comprises delivering the M(BH₄)_{y} to a fuel cartridge of the hydrogen consuming device. M can be selected from the group consisting of Li, Na, Mg, and K. The electrolytic cell may be a reverse fuel cell.

Additional metals which can react with M(BO₂)_{y} to produce M(BH₄)_{y} include Na and Mg. Alternatively a mixture or alloy of Na and Mg or Na and Al could be used as a fuel source for the hydrogen consuming device and the method can be adapted for recharging the mixture or alloy of Na and Mg or Na and Al.

The method further comprises transporting the spent fuel from the hydrogen consuming device and delivering the recycled fuel to the hydrogen consuming device. In one example the method comprises using a carrier liquid for transporting the spent fuel and the recycled fuel.

The apparatus comprises a housing for mounting a fuel cartridge of the hydrogen consuming device, a reaction vessel for converting the spent fuel to the fuel and a hydrogen supply for supplying hydrogen reactant to the reaction vessel. The apparatus further comprises a transport mechanism for transporting the spent fuel from the hydrogen consuming device and delivering the recycled fuel to the hydrogen consuming device. In one example, the transport mechanism comprises a pump for running a carrier liquid through a fuel cartridge of the hydrogen consuming device. The carrier liquid which forms a slurry with the spent fuel, residual fuel and catalyst and transports the spent fuel, residual fuel and catalyst to a separator present within the charger. The carrier liquid is then removed from the separator and the spent fuel present in the separator is introduced into a reaction vessel for conversion to fuel. Following conversion, the fuel put back into the separator and the carrier liquid is used to transport the fuel back to the fuel cartridge.

### BRIEF DESCRIPTION OF THE DRAWINGS

FIG. 1 is a schematic of a charger configured to recharge NaBH₄ fuel;

FIG. 2 depicts an example of a reaction vessel;

FIGS. 3A-3D depict the process for converting NaBO₂ to NaBH₄;

FIG. 4 depicts a fuel cartridge having individual capsules for containing fuel and spent fuel;

FIG. 5 depicts a mechanism for transporting NaBO₂ from the individual capsules contained in a fuel cartridge to the reaction vessel and transporting NaBH₄ back to the fuel cartridge;

FIG. 6 depicts a mechanism for transporting the individual capsules containing the spent fuel to the reaction vessel;

FIG. 7 depicts a mechanism for transferring the spent fuel from the capsule to the reaction chamber and transferring the recharged fuel back to the capsule;

FIG. 8 depicts another mechanism for transferring the spent fuel from the capsule to the reaction chamber and transferring the recharged fuel back to the capsule;

FIG. 9 depicts a charger configuration having two reaction vessels for converting NaBH₄ to NaBO₂;

FIG. 10 depicts a hydrogen supply which uses a reverse fuel cell to produce hydrogen gas;

FIGS. 11-12 depict charger configurations for alternative fuels;

FIGS. 13-14 depict charger configurations for alternative reactants used to convert M(BO₂)_{y} to M(BH₄)_{y};

FIGS. 15A-C depicts three charger configurations.

### DETAILED DESCRIPTION OF THE INVENTION

As used herein, the singular form “a”, “an”, and “the” includes plural references unless indicated otherwise. For example, “a” reaction includes one or more reactions. For example “an” inlet includes one or more inlets.

The described devices and methods are for recharging fuels used to generate hydrogen in a hydrogen consuming device such as a hydrogen fuel cell. Thus, when the fuel in the hydrogen consuming device gets depleted, the hydrogen fuel consuming device may be recharged by providing a source of hydrogen and heat as described below.

A number of solid fuels can be used to generate hydrogen for a hydrogen consuming device. For instance, members of the alkali metal group of the Mendeleev Chart, such as sodium, and various other metals, such as aluminum and magnesium, readily react with water in alkaline solution to produce hydrogen gas. An example of a balanced equation for the generation of hydrogen from aluminum is given as:

Al+NaOH+H₂O→NaAlO₂+1.5H₂⇑+Heat

Additionally, hydride salts of metals, alkali metals, and alkaline earth metals, and complex salts of metals, alkali metals, and alkaline earth metals, react with water to produce hydrogen. An example of a balanced equation for the reaction of a metal hydride with water to produce hydrogen is given as:

MgH₄+2H₂O→Mg(OH)₂+3H₂⇑+Heat

Still another class of solid fuels comprises borohydride salts of alkali metals, alkaline earth metals, ammonium, and alkyl ammonium and complex salts thereof. One such member is sodium borohydride. A balanced equation for the generation of hydrogen from sodium borohydride is given as:

NaBH₄+2H₂O→NaBO₂+4H₂⇑+Heat

In addition to sodium, other alkali metals suitable as hydrogen-generating fuels include lithium, potassium, and rubidium. Other metals in addition to aluminum suitable for use in hydrogen-generating fuels include magnesium and zinc. Examples of candidates from the group of hydride salts of metals, alkali metals, and alkaline earth metals, and complex salts thereof, in addition to the aforementioned magnesium hydride, include NaAlH₄, LiAlH₄, KAlH₄, NaGaH₄, LiGaH₄, KGaH₄, Mg(AlH₄)₂, Li₃AlH₆, Na₃AlH₆, and Mg₂NiH₄, and their mixtures. Finally, in addition to sodium borohydride, other suitable borohydride salts of alkali metals, alkaline earth metals, ammonium, and alkyl ammonium and complex salts thereof include LiBH₄, KBH₄, Mg(BH₄)₂, Ca(BH₄)₂, NH₄BH₄, and (CH₃)₄NBH₄, and their mixtures.

Additionally, the hydrogen-producing solid fuel may further comprise catalysts or catalyst precursors. Materials that are useful as these optional catalysts include transition metals, transition metal borides, and alloys and mixtures of these materials. Suitable transition metal catalysts are listed in U.S. Pat. No. 5,804,329, to Amendola, the entirety of which is incorporated herein by reference. Catalysts containing Group IB to Group VIIIB metals, such as transition metals of the copper group, zinc group, scandium group, titanium group, vanadium group, chromium group, manganese group, iron group, cobalt group, and nickel group are suitable in various configurations. Such catalysts lower the activation energy of the reaction of borohydrides with water to produce hydrogen. Specific examples of suitable transition metal elements include ruthenium, iron, cobalt, nickel, copper, manganese, rhodium, rhenium, platinum, palladium, chromium, silver, osmium, iridium, their compounds, their alloys, and their mixtures.

### I. Reaction Schemes

A number of chemical schemes exist in which a set of coupled chemical reactions can be used to recycle a fuel used to produce hydrogen gas. Examples of reaction schemes which can be used to recharge mixtures or alloys of Na and Mg or Na and Al, and M(BH₄)_{y} solid fuels are shown below.

For Na/Mg, the hydrogen production reaction is given as:

2Na+2Mg+4H₂O→2NaOH+2MgO+3H₂+Heat

The reaction products of the Na/Mg hydrogen-producing solid fuel are NaOH and MgO as shown above. The NaOH and the MgO can be converted back into Na and Mg through a series of coupled chemical reactions. The NaOH and MgO are first converted into NaCl and MgCl₂ by the balanced reaction:

2 NaOH+2 MgO+6 HCl+Heat→2 NaCl+2 MgCl₂+4 H₂O

The NaCl and MgCl₂ can then be converted to Cl₂ and Mg/Na by the reaction:

2 NaCl+2 MgCl₂+Heat→3 Cl₂+2 Mg+2 Na

The Cl₂ can then be reacted with H₂ to produce HCl by the reaction:

3 Cl₂+3 H₂→6 HCl+Heat

The HCl can then be reused to convert additional NaOH and MgO into Mg and Na.

The overall reaction is:

$$\frac{\begin{matrix}\begin{matrix}2 NaOH + 2 MgO + 6 HCl + Heat \to 2 NaCl + \\ 2 {MgCl}_{2} + 4 {H}_{2} O 2 NaCl + 2 {MgCl}_{2} + Heat \to \end{matrix} \\ 3 {Cl}_{2} + 2 Mg + 2 Na 3 {Cl}_{2} + 3 {H}_{2} \to 6 HCl + Heat\end{matrix}}{2 NaOH + 2 MgO + 3 {H}_{2} + Heat \to 2 Mg + 2 Na + 4 {H}_{2} O}$$

The byproduct of the overall reaction is H₂O, which can further be electrolytically converted to hydrogen and oxygen. The resulting hydrogen can then be used in the above reaction scheme to convert the Cl₂ into HCl.

For Na/Al, the hydrogen production reaction is given as

Na+Al+2 H₂O→NaAlO₂+2 H₂+Heat

The reaction product of the Na/Al hydrogen-producing solid fuel is NaAlO₂ as shown above. The NaAlO₂ can be converted back into Na and Al through a series of coupled chemical reactions. The NaAlO₂ is first converted into NaCl and AlCl₃ by the reaction:

NaAlO₂+4 HCl+Heat→NaCl+AlCl₃+2 H₂O

The NaCl and AlCl₃ can be converted to Cl₂, Al, and Na by the reaction:

AlCl₃+NaCl+Heat→2 Cl₂+Al+Na

The Cl₂ can then be reacted with H₂ to produce HCl by the reaction:

2 Cl₂+2H₂→4HCl+Heat

The HCl can then be reused to convert additional NaAlO₂ to Al and Na.

The overall reaction is:

$$\frac{\begin{matrix}\begin{matrix}NaA {lO}_{2} + 4 HCl + Heat \to NaCl + {AlCl}_{3} + \\ 2 {H}_{2} {OAlCl}_{3} + NaCl + Heat \to 2 {Cl}_{2} +\end{matrix} \\ Al + Na 2 {Cl}_{2} + 2 {H}_{2} \to 4 HCl + Heat\end{matrix}}{NaA {lO}_{2} + 2 {H}_{2} \to Al + Na + 2 {H}_{2} O}$$

The byproduct of the overall reaction is H₂O, which can further be electrolytically converted to hydrogen and oxygen. The resulting hydrogen can then be used in the above reaction scheme to convert the Cl₂ into HCl.

For M(BH₄)_{y}, the hydrogen production reaction is given as:

1 M(BH₄)_{y}+2y H₂O→4y H₂+1 M(BO₂)_{y}+Heat

The reaction product of the M(BH₄)_{y} hydrogen-producing solid fuel is M(BO₂)_{y} as shown above. The M(BO₂)_{y} can be converted back into M(BH₄)_{y} by reacting the M(BO₂)_{y} with a metal and hydrogen gas. Examples of metals that can be used include Al, Mg, and Na. The balanced reactions for converting M(BO₂)_{y} to M(BH₄)_{y} using Al, Mg, or Na are given as:

3 M(BO₂)_{y}+4y H₂+4y Al→2y Al₂O₃+2 M(BH₄)_{y}

1 M(BO₂)_{y}+2y H₂+2y Mg→2y MgO+1 M(BH₄)_{y}

1 M(BO₂)_{y}+(2y+1) H₂+2 Na→2 NaOH+1 M(BH₄)_{y}

The oxidized metal reaction products of the above reaction, Al₂O₃, MgO, and NaOH, can then be converted back to the reduced metal (i.e. Al, Mg, and Na) and reused to convert M(BO2)_{y} to M(BH₄)_{y}.

The Al₂O₃ can be converted directly into Al and O₂ by the reaction:

2 Al₂O₃→4 Al+3 O₂

The byproduct of the reaction is O₂ which can react with hydrogen to form water or be released into the atmosphere.

The MgO and NaOH can be converted to Mg and Na through a series of coupled chemical reactions.

The MgO is first converted into MgCl₂ by the reaction:

1 MgO+2 HCl+Heat→MgCl₂+1 H₂O

The MgCl₂ is then converted to Mg and Cl₂ by the reaction:

1 MgCl₂+Heat→1 Mg+1 Cl₂

The Cl₂ is then reacted with H₂ to produce HCl by the reaction:

2Cl₂+2 H₂→4 HCl+Heat

The HCl can then be reused to convert additional MgO to Mg, as shown above. The overall reaction for converting MgO to Mg is:

$$\frac{\begin{matrix}1 MgO + 2 HCl + Heat \to {MgCl}_{2} + {H}_{2} O {MgCl}_{2} + \\ Heat \to Mg + {Cl}_{2} {Cl}_{2} + {H}_{2} \to 2 HCl + Heat\end{matrix}}{MgO + {H}_{2} + Heat \to Mg + {H}_{2} O}$$

The byproduct of the reaction is H₂O.

The NaOH is first converted into NaCl by the balanced reaction:

2 NaOH+2 HCl→2 NaCl+2 H₂O+HEAT

The NaCl is then converted to Na and Cl₂ by the reaction:

2 NaCl→2 Na+Cl₂

The Cl₂ is then reacted with H₂ to produce HCl, by the reaction:

Cl₂+H₂→2 HCl+Heat

The HCl can then be reused to convert additional NaOH as shown above.

The overall reaction for converting NaOH to Na is:

$$\frac{\begin{matrix}2 NaOH + 2 HCl \to 2 NaCl + 2 H 2 O 2 NaCl + \\ Heat \to 2 Na + Cl 2 {Cl}_{2} + {H}_{2} \to 2 HCl + Heat\end{matrix}}{2 NaOH + {H}_{2} \to 2 Na + 2 H 2 O }$$

The byproduct of the reaction is H₂O.

### II. Charger Configuration

A charger is described below which is configured to recharge a fuel used to produce hydrogen for a hydrogen consuming device such as a hydrogen fuel cell. The charger can be configured such that the reactants which react with the spent fuel, in the process of recharging the fuel, can be self contained within the charger and will not require replenishing after multiple recharge cycles. Instead the reactants are recycled through electrolysis or by reacting with hydrogen or a combination of the two. Alternatively, some or all of the reactants can be supplied to the charger after every recharge cycle.

While the device below is described in terms of NaB and NaBO₂, the description applies to devices that utilize M(BH₄)_{y} to produce M(BO₂)_{y} and that utilize the reaction schemes discussed above to regenerate the spent fuel.

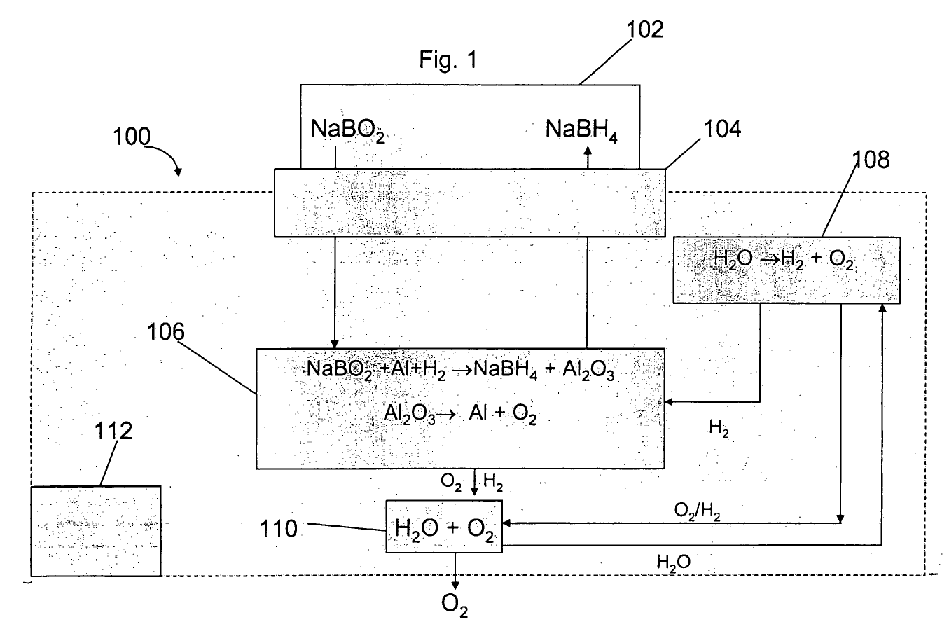

FIG. 1 is a schematic of charger 100 for recharging fuel cartridge 102. Fuel cartridge 102 is configured to store both the fuel (NaBH₄), the spent fuel (NaBO₂) and the catalyst. Charger 100 is configured to convert NaBO₂ to NaBH₄.

Charger 100 contains a housing 104 for attaching a fuel cartridge 102. Fuel cartridge 102 may or may not be attached to a hydrogen consuming device prior to attachment to the charger 100. Whether or not fuel cartridge 102 is attached to the hydrogen consuming can depend on whether or not the fuel cartridge 102 is removable from the hydrogen consuming device. Alternatively, the charger and the hydrogen consuming device may be incorporated into a single device.

Housing 104 may contain additional elements, such as flow channels for transferring NaBO₂ to the charger and for transferring NaBH₄ to fuel cartridge 102. The configuration of housing 104 and the additional elements depends on the mechanisms by which NaBH₄ and NaBO₂ are transferred to and from cartridge 102. The NaBO₂ contained within cartridge 102 is transferred to a reaction vessel 106 contained within charger 100. Reaction vessel 106 is configured to convert NaBO₂ to NaBH₄ and electrolytically convert Al₂O₃ to Al and O₂. Additionally, the charger contains a hydrogen supply 108 which supplies hydrogen that is used in the conversion of NaBO₂ to NaBH₄. In one system, as depicted in FIG. 1, the hydrogen supply is an electrolytic cell that converts H₂O to H₂ and O₂. Reaction vessel 106 is further configured to allow for the egression of excess H₂ and O₂ into a second vessel 110 which reacts the excess H₂ or O₂ with excess H₂ or O₂ generated in hydrogen supply 108. Details of reaction vessel 106, mechanisms for transferring NaBO₂ from cartridge 102 to the reaction vessel, and mechanisms for transferring NaBH₄ from cartridge 102 to reaction vessel 106 are discussed below.

Charger 100 further contains a power supply 112 which can be plugged into a wall socket to supply power to charger 100.

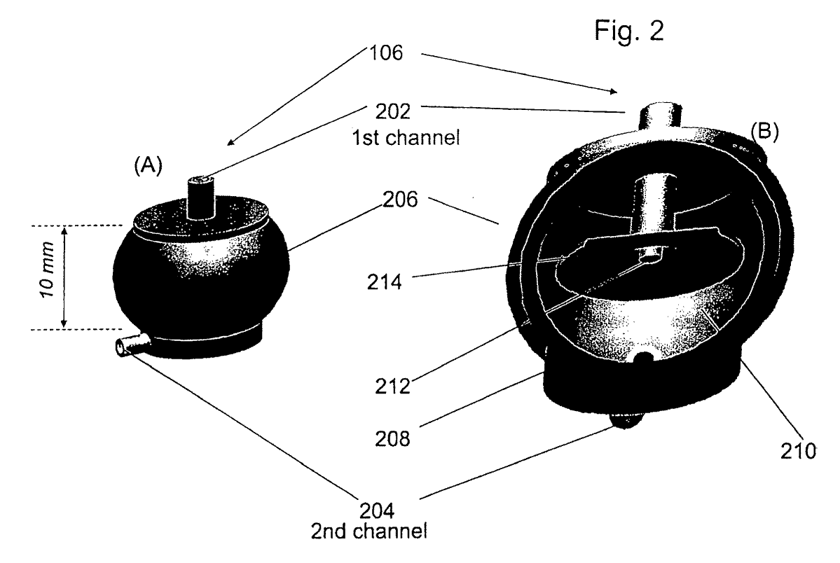

In one system, depicted in FIGS. 2A and 2B, reaction vessel 106 is made from stainless steel and surface 206 is coated with ceramic heat tiles. Alternatively, the reaction vessel can be made from any material that is not reactive and can withstand temperatures of greater than 1000° C. Reaction vessel 106 contains, a first channel 202, at the top of reaction vessel 106, which allows hydrogen to pass to reaction vessel 106 and hydrogen and oxygen to leave reaction vessel 106. Reaction vessel 106 contains a second channel 204 located at the bottom, which allows NaBO₂ to enter reaction vessel 106 and NaBH₄ to exit reaction vessel 106. Reaction vessel 106 contains a heating filament 208 for heating reaction vessel 106 to the appropriate temperature. The interior of reaction vessel 106 is lined with a tungsten coating 210, which is employed as the anode for the electrolytic conversion of Al₂O₃ to O₂ and Al. The cathode 212, for the electrolytic reaction, is a tungsten coated platinum filament and is present within first channel 202. Alternatively, the cathode 212 can be made from any material that is not reactive and can withstand temperatures of greater than 1000° C. The base of first channel 202 contains an oxygen shield 214 which promotes the egression of oxygen, formed at cathode 212, from the reaction vessel 106.

As discussed above, reaction vessel 106 is configured for two reactions. One reaction is between NaBO₂, H₂ and Al to produce NaBH₄. The second reaction, conversion of Al₂O₃ to Al and O₂, is an electrolysis reaction and requires that reaction vessel 106 be configured as an electrolytic cell.

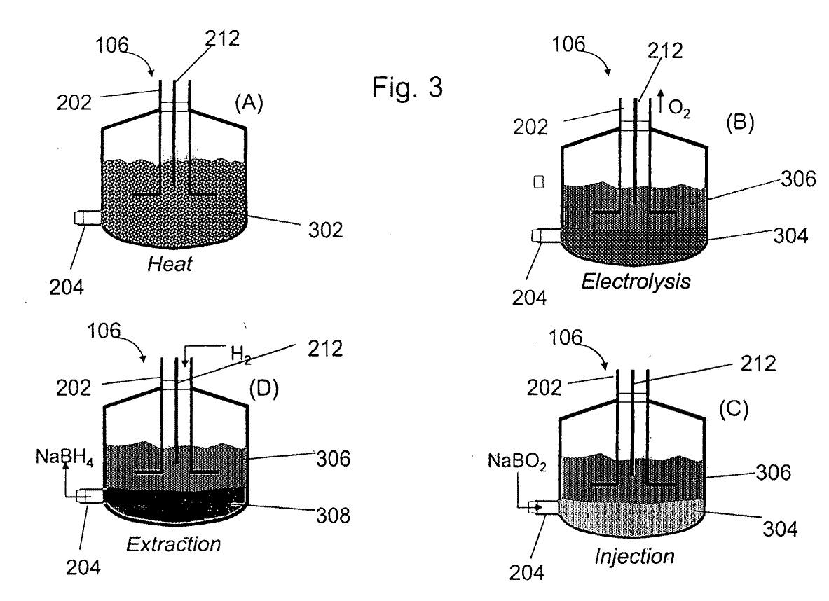

FIGS. 3A-3D depict the reaction vessel at different stages of the process for converting NaBO₂ to NaBH₄. The reaction vessels in FIGS. 3A-3D contain the first channel 202, the second channel 204, and cathode filament 212. Prior to receiving NaBO₂, reaction vessel 106 contains Al₂O₃ (alumina) and Na₃AlF₆ (cryolite). In the first step, shown in FIG. 3A, the solid alumina and cryolite are heated to a temperature of about 1000° C. to form an alumina-cryolite solution 302. Alternatively, the temperature that cryolite can be molted into liquid can be anywhere in the range of 750° C.-1100° C. depending on the composition of cryolite and additives

In the second step, shown in FIG. 3B, the temperature of reaction vessel 106 is maintained at about 1000° C., and the alumina is electrolytically converted to aluminum. The aluminum, which has a melting temperature of about 669.7° C., is formed as a liquid. The liquid aluminum is immiscible and denser than the alumina-cryolite solution, causing it to separate to the bottom of reaction vessel 106. The oxygen created, at the cathode, during the electrolytic conversion egresses from the reaction vessel through the first channel 202. When the alumina has been converted to aluminum, and the oxygen has been removed from the vessel 106, the reaction vessel 106 is cooled to a temperature of about 700° C. at which the aluminum is a liquid 304 and the cryolite forms a solid 306 on the surface of the liquid aluminum. Reaction vessel 106 should contain enough aluminum so that the second channel 204 does not get blocked by the solid cryolite.

In the third step, as depicted in FIG. 3C, liquid NaBO₂ at a temperature of about 57° C. to 270° C. is injected into the liquid aluminum layer 304 at the bottom of the reaction vessel though the second channel 204. The NaBO₂ in the cartridge is typically a hydrate (i.e. NaBO₂·xH₂O, where x is 1-4), which has a melting temperature in the range of 57° C. to 270° C. The melting temperature depends on the number of water molecules present in the hydrate. During the injection, the reaction vessel is maintained at about 700° C. Following injection of the NaBO₂ into the liquid aluminum layer 304, the water present in the hydrate reacts with the Al to form Al₂O₃ and the NaBO₂ solidifies. The reaction vessel is then cooled to a temperature of about 600° C. at which point the aluminum solidifies and forms a solid mixture with NaBO₂.

In the fourth step, depicted in FIG. 3D, hydrogen is passed through the first channel 202. When the hydrogen gas reaches the solid mixture of aluminum and NaBO₂ 308, the hydrogen reacts with the aluminum and NaBO₂ mixture to form a foam like or porous solid Al₂O₃ structure and liquid NaBH₄. During this reaction, the reaction vessel is maintained at a temperature of about 600° C. The injection of hydrogen increases the pressure in reaction vessel 106. The increased pressure has two effects. First it pushes the liquid NaBH₄ out of reaction vessel 106 through channel 204, back toward the fuel cartridge. Second, the increased hydrogen pressure prevents the NaBH₄ from decomposing above 400° C. The hydrogen pressure is maintained until the liquid NaBH₄ is pushed out of reaction vessel 106 at which point the hydrogen remaining in reaction vessel 106 egresses through channel 202. When the NaBH₄ has been removed from reaction vessel 106, bottom layer 308 contains solid alumina and top layer 306 contains cryolite. Reaction vessel 106 is then heated as discussed for FIG. 3A, and the process is repeated.

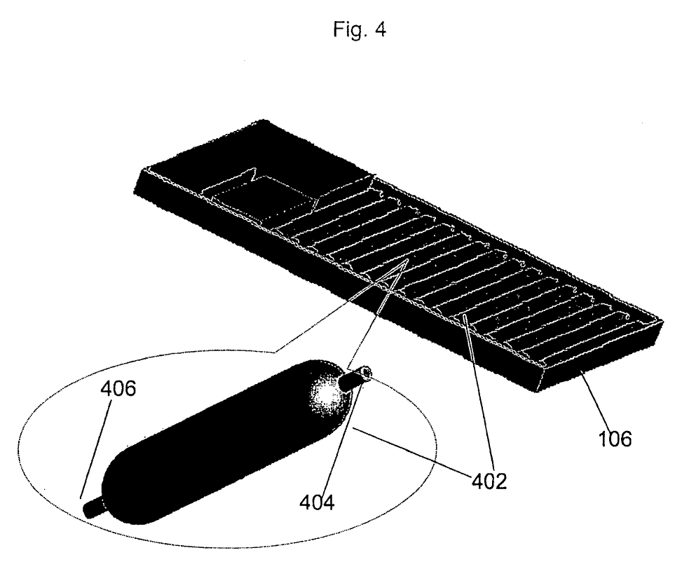

In one system, the NaBH₄, the catalyst, and the NaBO₂ reaction product are contained in individual capsules 402 fixed within cartridge 102, as shown in FIG. 4. The capsules contain two flow channels 404 and 406 which can be configured to allow the passage of NaBH₄, NaBO₂ or catalyst from capsule 402. The capsules are made from a material that allows the passage of water and hydrogen into the capsule but does not allow the passage of NaBH₄, NaBO₂ or catalyst out of the capsule except through flow channels 404 and 406. Materials such as a micorporous stainless steel mesh or certain polymeric or plastic materials such as polystyrene (EPS), PTFE, carbon, metal or alloy powder, polyurethane etc, can be used to make the capsules. Any number of capsules can be contained in the cartridge. In one system, the number capsules would be in the range of about 1-500. Preferably, the internal volume of the capsules would in the range of about 0.01 ml-100 ml. The reaction chamber in reaction vessel 106 (FIG. 2) would have a volume of about 1-100 ml when the internal volume of one of the capsules is about 1 ml. Alternatively, the volumes of the capsule and reaction chamber can be changed according to different applications.

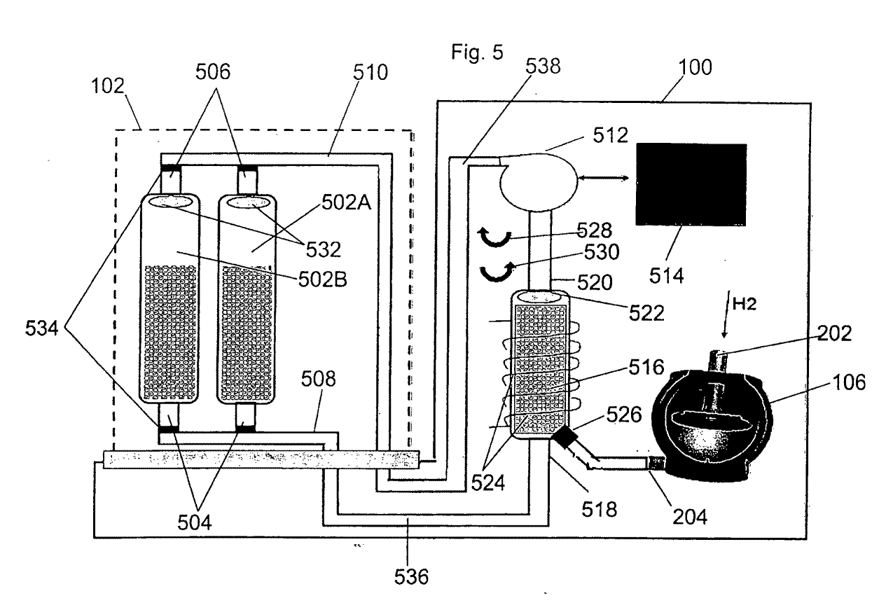

One mechanism for delivering NaBO₂ from the fuel cartridge to the reaction vessel and for delivering the NaBH₄ from reaction vessel to the fuel cartridge 102 is shown in FIG. 5. In this example, the NaBH₄ fuel, the NaBO₂ reaction product, and the catalyst are contained in a first 502A and a second capsule 502B fixed within cartridge 102. Though only a first and second capsule are shown in this example any number of capsules may be contained within the cartridge. The number of capsules will depend in part on the size of the cartridge.

Each of the capsules have two flow channels 504 and 506 for introducing a carrier liquid used to transport the NaBO₂ out of the capsule and transport NaBH₄ into the capsules. Carrier liquids, that are suitable to transport NaBH₄ and NaBO₂, include mineral oil and secondary alcohols that do not react with NaBO₂ or NaBH₄. Each of the flow channels 504 are connected to a central flow channel 508 and each of the flow channels 506 are connected to a central flow channel 510. The central flow channels 510 and 508 interface with charger 100. Preferably, the charger interface has two fittings (not shown) with a diameter of less than about 0.1-100 mm or has a signal coaxial fitting (not shown) with a diameter of less than about 0.1-100 mm. Alternatively, the diameters of the fittings can be changed according to different applications. Each of the flow channels, 504 and 506, have a valve 534, which controls the opening and the closing of the flow channels.

To remove NaBO₂ from the cartridge a pump 512, in fluid communication with a liquid carrier reservoir 514 containing the carrier liquid, pumps the carrier liquid through flow channel 538. The carrier liquid enters the charger through central flow channel 510 and into one of the individual capsules through flow channel 506. The capsule through which the carrier liquid is being pumped has its valves 534 in the open position. The carrier liquid forms a slurry with NaBO₂, catalyst and any NaBH₄ present in the capsule. The slurry then exits the individual capsules through flow channel 504, exits fuel cartridge 102 through central flow channel 508, enters flow channel 536 and enters a separator 516 present within the charger 100. The direction of flow during the process of removing NaBO₂ from the capsules is depicted by arrow 530. Separator 516 is attached to reaction vessel 106 through a second flow channel 204. Separator 516 has a valve 526 that prevents the passage of carrier liquid to reaction vessel 106 and is closed when the carrier liquid is present in the separator 516. The separator has two flow channels 518 and 520. The slurry containing NaBO₂ enters separator 516 through flow channel 518. The combination of pump 512, reservoir 514, separator 516, and any one of the capsules 502 form a closed loop through which the carrier liquid can flow.

Separator 516 has a filter 522 which allows for the passage of the carrier liquid through flow channel 520 while preventing the NaBO₂, NaBH₄, and catalyst from passing through the separator into the liquid carrier reservoir 514. Once the carrier liquid has passed filter 522, the carrier liquid exits separator 516 through flow valve 520 and enters liquid reservoir 514. The carrier liquid that passes through separator 516 can be further pumped into capsules 502 and used to extract additional NaBO₂ from capsules 502.

Following the transfer of NaBO₂ from the capsules to the separator, pump 512 removes the remaining mineral oil from separator 516 and transports the carrier liquid back to reservoir 514. Removal of the carrier liquid from separator 516 is achieved by closing valves 534 and evacuating the carrier liquid from the separator 516. Pump 512 creates a vacuum that causes the carrier liquid to withdraw from separator 516 to reservoir 514.

The separator is surrounded by a heating coil 524, and after removing the carrier liquid from the separator, the heating coil is activated and heats the separator 516 to a temperature of about 57° C.-270° C., which liquefies the NaBO₂. As discussed above the NaBO₂ is a hydrate. Following liquefaction of the NaBO₂, valve 526 is set to open and the liquid NaBO₂ is transferred to reaction vessel 106 through the flow channel 204. In this example, separator 516 is situated above reaction vessel 106 so that liquid NaBO₂ can drain into reaction vessel 106. Additionally, the NaBO₂ may get drawn into reaction vessel 106 by introducing a vacuum through flow channel 202 or may get pushed into reaction vessel 106 by pumping H₂ into the separator and increasing the pressure. The catalyst and any residual NaBH₄ that remain in the separator are prevented from entering the reaction vessel by a filter (not shown) in valve 526.

The NaBO₂ is then converted to NaBH₄ as discussed above. Prior to transferring the NaBH₄ from reaction vessel 106 to separator 516, the valves 534 on one of the capsules are set to open. Pump 512 then pumps carrier liquid through the separator, and through the open capsule. The carrier liquid is pumped in the opposite direction as depicted by arrow 528. Valve 526 on the separator 516 is then set to open. The hydrogen pressure in flow channel 204 prevents the carrier liquid from entering reaction vessel 106. The pressure from the hydrogen in the reaction vessel 106 causes injection of the NaBH₄ into separator 516 through flow channel 204. Additionally, as discussed above, the increased hydrogen pressure prevents the NaBH₄ from decomposing.

The NaBH₄ injected as droplets into the separator 516 makes contact with the carrier liquid, cools, solidifies and forms a slurry with the carrier liquid. The slurry may also contain the catalyst and residual NaBH₄ that was present in separator 516. The cooling of NaBH₄ by the carrier liquid and the formation of a slurry allows for the formation and transportation of small particles of NaBH₄ as opposed to a solid mass, which would form if the liquid NaBH₄ was directly transported to the capsules 402 without the use of the carrier liquid. It is preferable for the NaBH₄ to be in the form of a powder because a powder exposes a larger surface area of NaBH₄ and enhances accessibility to the fuel by water.

The slurry containing the NaBH₄ is then pumped from separator 516 to one of the capsules 502. The slurry leaves the separator through flow channel 518 and enters the capsule through flow channel 504 via flow channel 536 and central flow channel 508. Once the NaBH₄ has been transferred to the capsules 502, the valve on flow channel 504 is closed and the carrier liquid remaining in the capsules is drawn out and transferred to reservoir 514. The capsules contain a filter 532, located near flow channels 506, which allows the passage of the carrier liquid through the capsules but prevents the NaBH₄ and catalyst from escaping the capsules when being transported to the capsules 402 from the separator. Following removal of the carrier liquid from the capsules the recharging of the NaBH₄ fuel is complete.

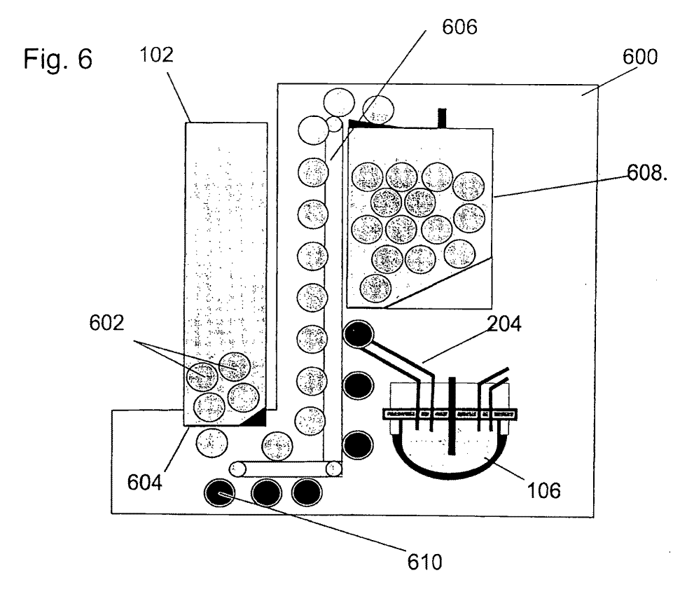

Another system for transferring the NaBO₂ from cartridge 102 is depicted in FIG. 6. The NaBO₂ is contained in individual capsules 602 which can be removed from cartridge 102. When the cartridge 102 is attached to charger 100, an opening or “trap door” 604 is created, which allows the capsules to exit the device and enter charger 600. The capsules are then transported using a conveyor mechanism 606 to a chamber 608. Chamber 608 queues the capsules 602. The capsules are then individually attached to the reaction vessel 106 through flow channel 204. The NaBO₂ is then introduced into reaction vessel 106. The NaBO₂ is then converted to NaBH₄. As discussed above the hydrogen pressure in the reaction vessel is used to push the NaBH₄ out of the reaction vessel through flow channel 204 and back into the capsules. The refueled capsules 610 are then transported back to fuel cartridge 102 using conveyor mechanism 606. Once the capsules 604 have been refueled, then recharging is complete.

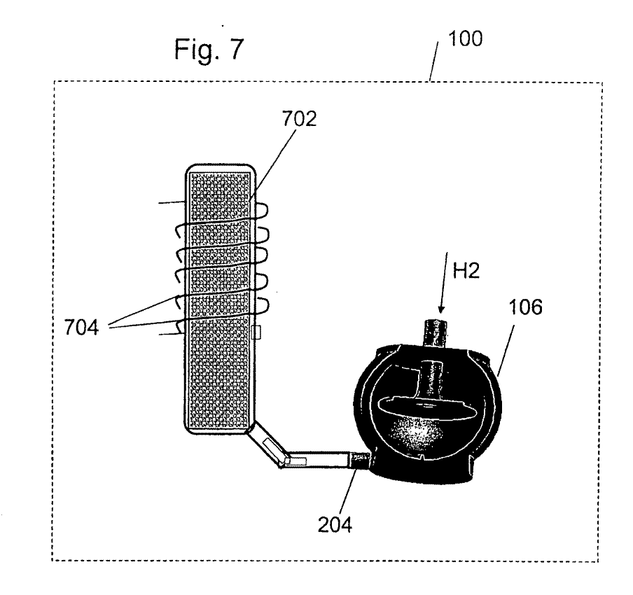

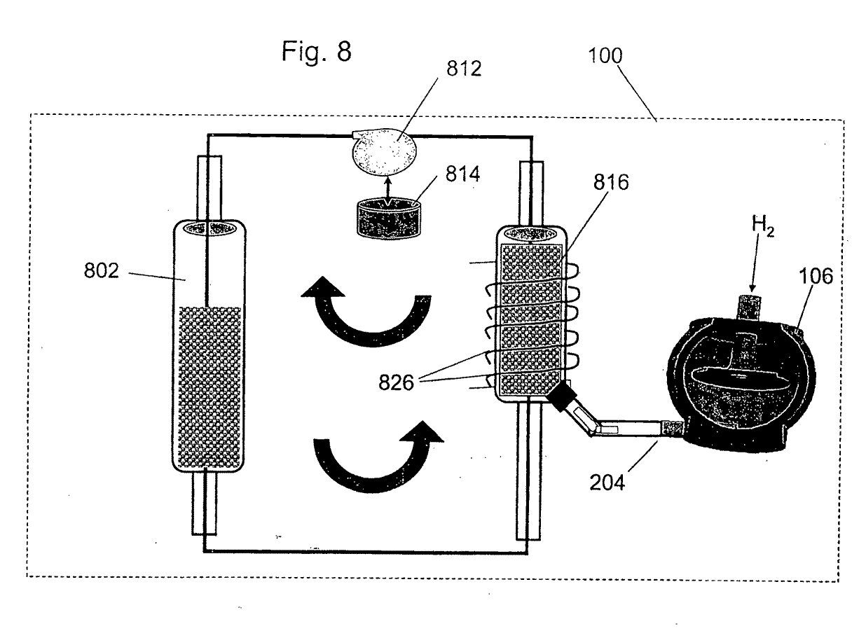

FIGS. 7-8 depict two mechanisms for attaching the capsules removed from the cartridge to reaction vessel 106. The capsule 702, in FIG. 7, is first situated into a heating coil and attached to the reaction vessel 106 through flow channel 204. Following attachment of capsule 702 to reaction vessel 106, the heating coil 704 heats the capsule to about 57° C. to 270° C. which liquefies the NaBO₂. The NaBO₂ is then drained into reaction vessel 106. The NaBO₂ is converted to NaBH₄ and the NaBH₄ is then injected back into the capsule. Following injection of the NaBH₄ into capsule 702, capsule 702 is removed from the heating coil and is transported back to the cartridge, as shown in FIG. 6.

In FIG. 8 capsule 802 is put in fluid contact with a separator 816. The separator 816 is attached to reaction vessel 106 through flow channel 204. The separator 816 and capsule 802 are attached to a pump 812 which is in fluid contact with a carrier liquid reservoir 814. The separator is also in contact with a heating coil 826. The mechanism for transferring the NaBO₂ from the capsule and NaBH₄ to the capsule is similar to the mechanism depicted in FIG. 5 and described above.

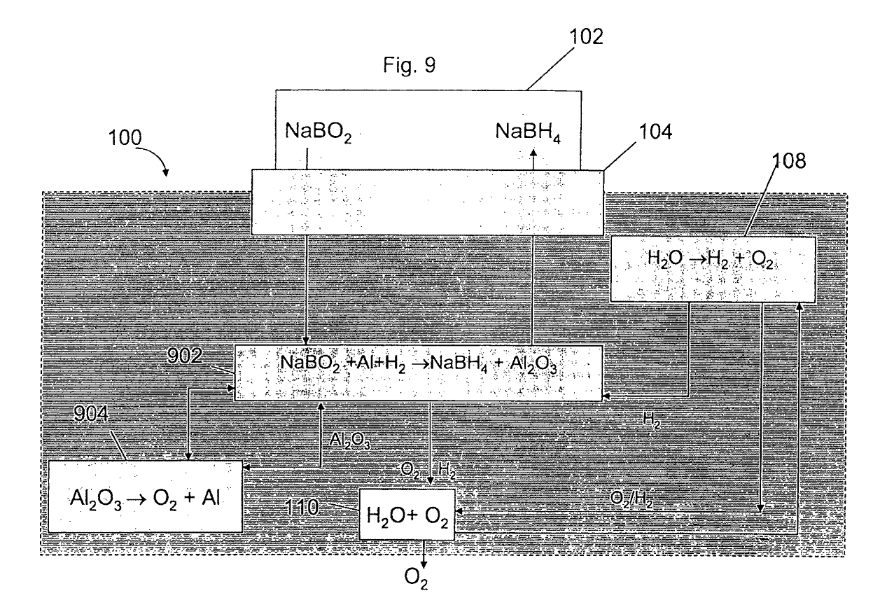

In another system, the conversion of NaBO₂ to NaBH₄ can be separately performed in two reaction vessels as depicted in FIG. 9. The first reaction vessel 902 is configured to receive the NaBO₂, convert NaBO₂ to NaBH₄ and release NaBH₄. The first reaction vessel 902 is additionally configured to receive Al from the second reaction vessel 904, release Al₂O₃ to the second reaction vessel 904 and receive H₂ from hydrogen supply 108. The second reaction vessel 904 is configured to convert Al₂O₃ to Al and O₂ and contains the necessary components as discussed above. The second reaction vessel 904 is configured in a manner similar to reaction vessel 106 (FIG. 2). Upon conversion of Al₂O₃ to Al and O₂ the Al is transported to the first reaction vessel 902. Liquid or solid NaBO₂ is then introduced into the first reaction vessel 902. The mixture of Al and NaBO₂ is then cooled to about 600° C. at which the mixture solidifies. Hydrogen is then introduced into the first reaction vessel 902 and reacts with the mixture to form liquid NaBH₄ and solid Al₂O₃. The hydrogen can be used to push the liquid NaBH₄ out of the first reaction vessel 902. Following completion of the conversion of NaBO₂ to NaBH₄, the Al₂O₃ is transported back to the second reaction vessel 904 by pumping liquid cryolite into the first reaction vessel 902 to solvate the Al₂O₃ and then pumping the Al₂O₃ cryolite solution back to the second reaction vessel 904. The process is then repeated.

In another system each of the reaction vessels 902 and 904 may be configured to be dual purpose reaction vessels in a manner similar to reaction vessel 106 (FIG. 2). For example Al₂O₃ is converted to Al and O₂ in the first reaction vessel 904. The Al is then transferred to the first reaction vessel 902. In a first round of recharging NaBO₂ is introduced into the first reaction vessel 902. The Al in the first reaction vessel 902 is then used in combination with the hydrogen to convert the NaBO₂ to NaBH₄ and produce Al₂O₃. Following the conversion of NaBO₂ to NaBH₄ and removal of NaBH₄ from the first reaction vessel 902, cryolite remaining in the second reaction vessel 904 is transferred to the first reaction vessel 902. Al₂O₃ in the first reaction vessel 902 is converted to Al and transferred back to the second reaction vessel 904. In a second round of recharging, NaBO₂ is then introduced into the second reaction vessel 904 along with hydrogen from the hydrogen supply 108 and is converted to NaBH₄. Thus, the conversion of NaBO₂ and Al₂O₃ alternates reaction vessels. This process of using the reaction vessels in concert alleviates the need to transport the solid Al₂O₃ between the reaction vessels.

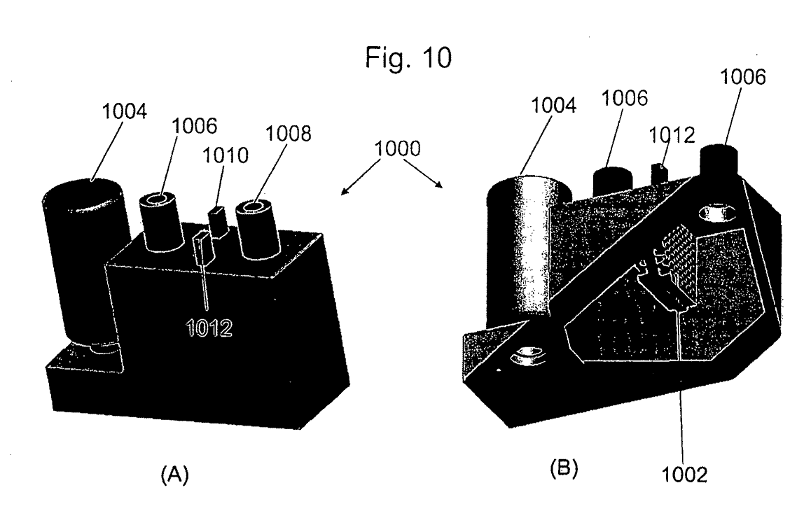

An example of an electrolytic cell hydrogen supply 1000 (FIG. 1, 108) used to supply hydrogen to the reaction vessel is depicted in FIGS. 10A-10B. In this system hydrogen supply 1000 is a reverse fuel cell which uses an electrical potential to convert water into O₂ and H₂. The fuel cell membrane 1002 is shown in FIG. 10B. Hydrogen supply 1000 contains a tank 1004 to store water, an outlet 1006 for oxygen, an outlet 1008 for H₂, and a positive 1010 and negative electrode 1012. Water supply tank 1004 supplies water to fuel cell membrane 1002 while a potential is applied across the electrodes 1010 and 1012. The water is electrolytically split into H₂ and O₂. The H₂ exits the through outlet 1008 and is supplied to reaction vessel 106 (not shown), while O₂ exits outlet 1006. The O₂ may be released into the atmosphere or directed to another reactor 110 (FIG. 1) to react with excess H₂ from reaction vessel 106.

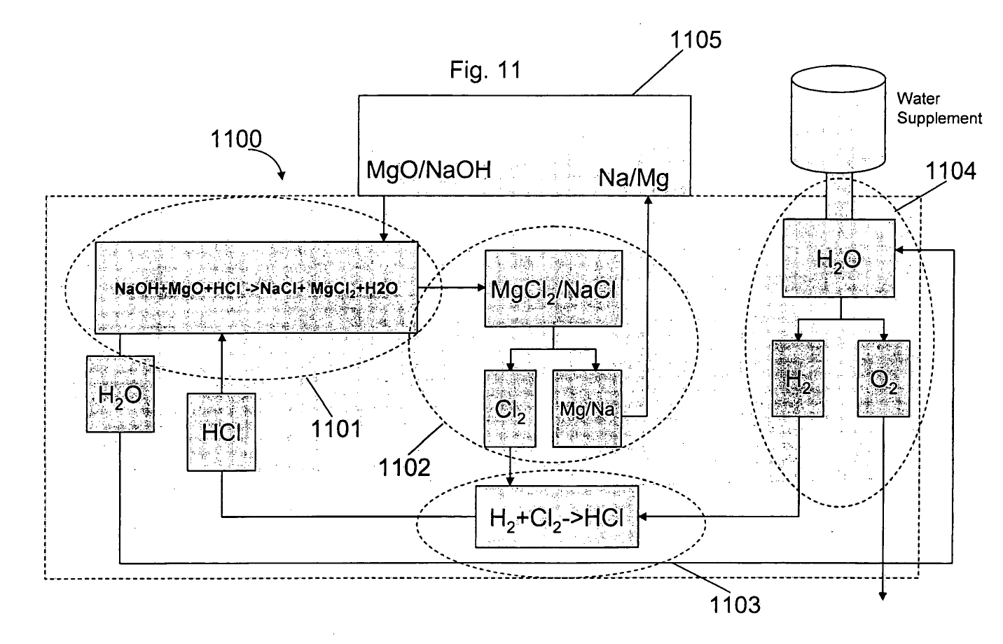

Additional fuels such as alloys or mixtures of Na and Mg or Na and Al alloys, as well as other borohydrides, of the formula M(BH₄)_{y}, can be used to produce hydrogen and recharged in similarly constructed chargers. Additionally metals reactants, such as Mg or Na, can be used to reduce M(BO₂)_{y} to M(BH₄)_{y}. FIGS. 11-14 depict alternative charger configuration using alternative fuels and alternative reactants for recharging the fuel.

FIG. 11 depicts a device 1100 for recharging a fuel cartridge 1105 containing a mixture or alloy of Na and Mg as a solid fuel source. Fuel cartridge 1105 provides the product of the spent fuel (MgO and NaOH ) to a first reaction vessel. The spent fuel can be provided using individual capsules which contain the spent fuel and are present in fuel cartridge 1105 of the hydrogen consuming device, as discussed above. First reaction vessel 1101 contains HCl. The HCl reacts with MgO and NaOH to produce NaCl, MgCl₂ and H₂. The MgCl₂ and NaCl are then transported to a second reaction vessel 1102. The MgCl₂ and NaCl are then electrolytically converted to solid mixture or alloy of Mg and Na and Cl₂ gas. The mixture or alloy of Na and Mg is then transported back to fuel cartridge 1105. If individual capsules are being used, the mixture or alloy of Na and Mg can be transported back into the individual capsules. The capsules can then be reinserted into fuel cartridge 1105. The Cl₂ gas is transported to a third reaction vessel 103, along with H₂ from an H₂ supply 1104. The Cl₂ and the H₂ react to produce HCl. The HCl produced in the third reaction vessel 1103 is then transported to the first reaction vessel 1101 and reused. Optionally, hydrogen supply 1104 can be an electrolytic cell which splits water into hydrogen and oxygen. Additionally the first 1101 and second 1102 reaction vessels can be combined into a single reaction vessel as previously discussed.

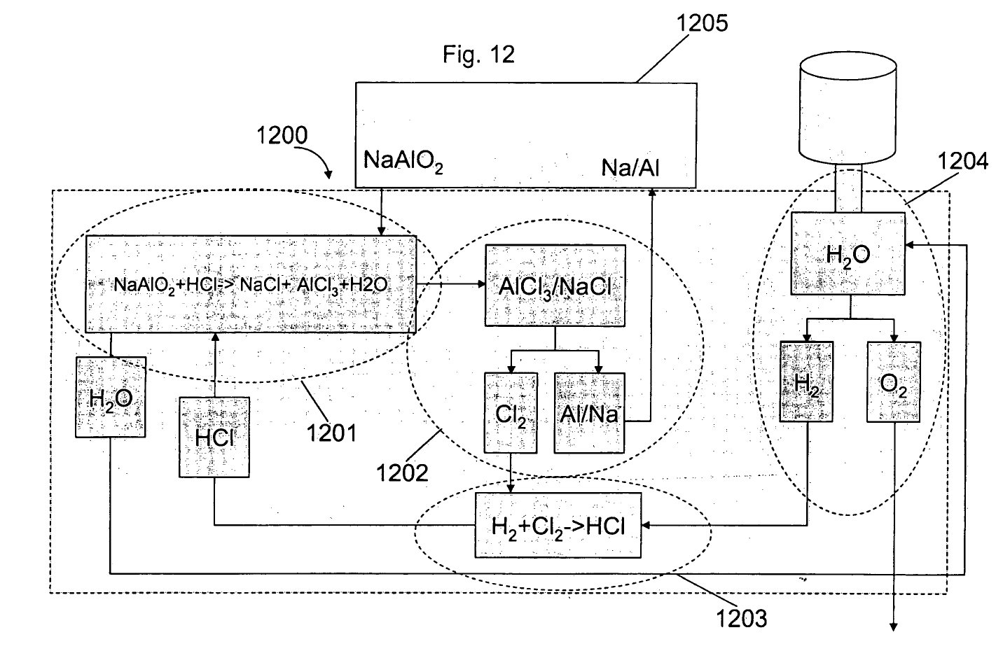

FIG. 12 depicts a device 1200 for recharging a fuel cartridge 1205 which contains a mixture or alloy of Na and Al as a solid fuel source. The fuel cartridge 1205 provides the product of the spent fuel (NaAlO₂), to a first reaction vessel 1201. The spent fuel can be provided using individual capsules which contain the spent fuel and are present in fuel cartridge 1205. The first reaction vessel 1201 contains HCl. The NaAlO₂ reacts with the HCl to produce NaCl, AlCl₃ and H₂O. The NaCl and AlCl₃ are then transported to a second reaction vessel 1202. The AlCl₃ and NaCl are then electrolytically converted to a mixture or alloy of Na and Al and Cl₂. The a mixture or alloy of Na and Al is then transported back to fuel cartridge 1205. If individual capsules are being used, the mixture or alloy of Na and Al can be transported back into the individual capsules. The capsules can then be reinserted into fuel cartridge 1205. The Cl₂ is transported to a third reaction vessel 1203, along with H₂ from a H₂ supply 1204. The Cl₂ and the H₂ react to produce HCl. The HCl produced in the third reaction vessel 1203 is then transported to the first reaction vessel 1201 and reused. Optionally, hydrogen supply 1204 can be an electrolytic cell which splits water into hydrogen and oxygen. Additionally the first and second reaction vessels can be combined into a single reaction vessel as previously described.

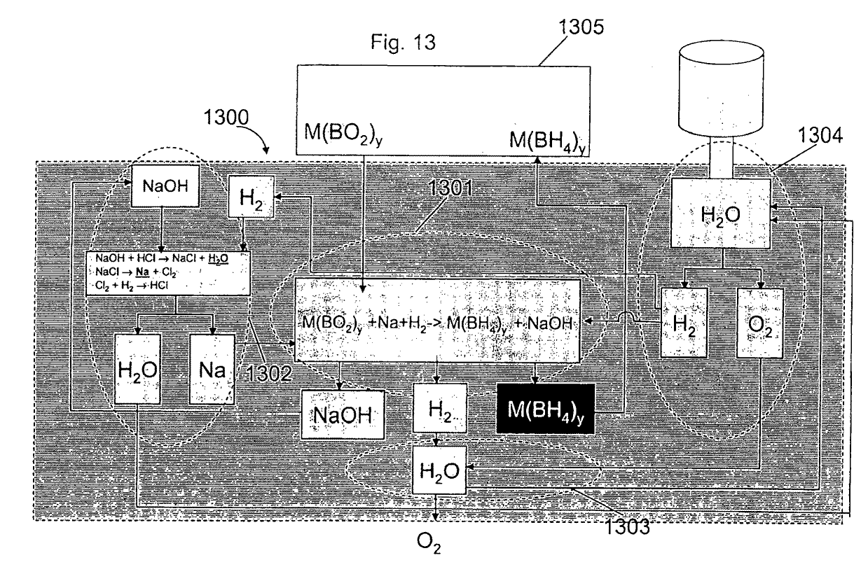

FIG. 13 depicts a device 1300 for recharging a fuel cartridge 1305 which uses M(BH₄)_{y} as a fuel for producing hydrogen and which uses Na in the reaction which converts M(BO₂)_{y} to M(BH₄). Fuel cartridge 1305 provides the spent fuel (M(BO₂)_{y}) to a first reaction vessel 1301 which contains Na and H₂. The spent fuel can be provided using individual capsules which contain the spent fuel and are present in fuel cartridge 1305. The M(BO₂)_{y} then reacts with Na and H₂ to form M(BH₄)_{y} and NaOH. The NaOH produced in the first reaction vessel 1301 is transported to a second reaction vessel 1302. The NaOH is then converted to Na and H₂O using a set of coupled chemical reactions as show in the second reaction vessel. The Na produced in the second reaction vessel 1302 is then transported to the first reaction vessel 1301 and used to convert M(BO₂)_{y} to M(BH₄)_{y}. The recycled M(BH₄)_{y} is transported back to fuel cartridge 1305. If individual capsules are being used, the M(BH₄)_{y} can be placed into the individual capsules. The capsules can then be reinserted into fuel cartridge 1305. Optionally, H₂ in the first reaction vessel 1301 is supplied from a hydrogen supply 1304. Optionally, hydrogen supply 1304 is an electrolytic cell which splits water into hydrogen and oxygen. In the case when hydrogen supply 1304 is an electrolytic cell, the water produced in the second reaction vessel 1302 can be recycled by supplying it to hydrogen supply 1304. Additionally the first 1301 and second 1302 reaction vessels can be combined into a single reaction vessel as previously discussed. The third 1303 reaction vessel combines hydrogen and water to produce water.

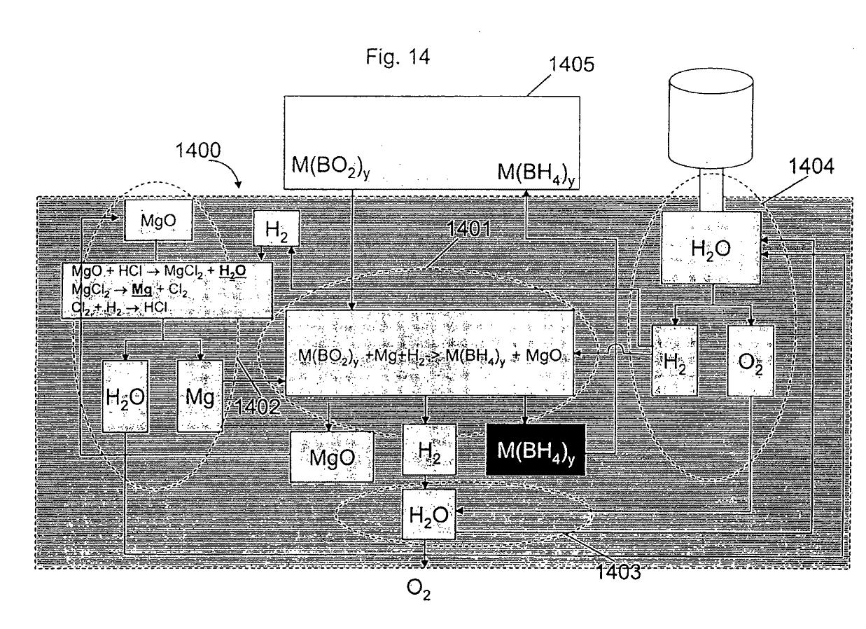

FIG. 14 depicts a device 1400 for recharging a fuel cartridge 1405 which uses M(BH₄)_{y} as a fuel for producing hydrogen and which uses Mg in the reaction which converts M(BO₂)_{y} to M(BH₄)_{y}. Fuel cartridge 1405 provides the spent fuel, M(BO₂)_{y}, to a first reaction vessel 1401 which contains Mg and H₂. The spent fuel can be delivered using individual capsules which contain the spent fuel and are present in fuel cartridge 1405. The M(BO₂)_{y} reacts with Mg and H₂ to form M(BH₄)_{y} and MgO. The MgO produced in the first reaction vessel 1401 is transported to a second reaction vessel 1402. The MgO is then converted to Mg and H₂O using a set of coupled chemical reactions. The Mg produced in the second reactor 1102 is then transported to the first reaction vessel 1401 and reacted with M(BO₂)_{y} to form M(BH₄)_{y}. The recycled M(BH₄)_{y} is transported back to the fuel cartridge 1405. If individual capsules are being used, the M(BH₄)_{y} can be put back into the individual capsules. The capsules can then be reinserted into the fuel cartridge 1405. The H₂ in the first reaction chamber 1401 is supplied from a hydrogen supply 1404. Optionally, the hydrogen supply 1404 is an electrolytic cell which splits water into hydrogen and oxygen. In the case when the hydrogen supply 1404 is an electrolytic cell, the water produced in the second reaction vessel 1402 can be recycled by supplying it to the hydrogen supply 1404. Additionally the first 1401 and second 1402 reaction vessels can be combined into a single reaction vessel as previously discussed. The third 1403 reaction vessel combines hydrogen and water to produce water.

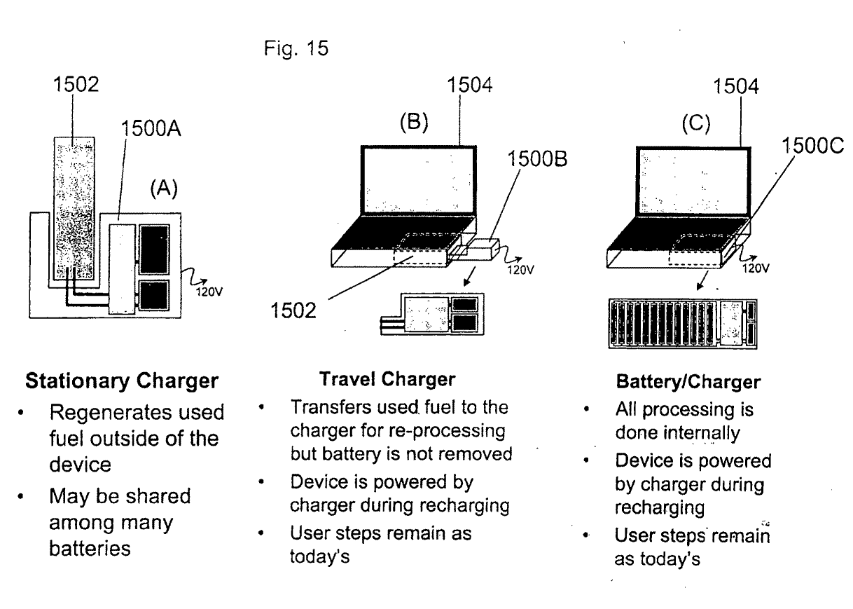

FIGS. 15 A-C depicts three preferred charger configurations. In FIG. 15A charger 1500A is a stationary charger. Fuel cartridge 1502, which may or may not be attached to the hydrogen consuming device, such as a fuel cell battery, is attached to charger 1500A. This configuration is useful for example when removing a fuel cell battery from a device and externally recharging it. Charger 1500A in this configuration can be shared among many batteries. The power necessary for recharging is provided by plugging charger 1500A into a power source such as a wall socket.

In FIG. 15B charger 1500B is attached, for example, to a hydrogen fuel cell battery which is internal to an electronic device 1504. The electronic device may be a stationary device such as remote sensor or a portable device such as a laptop or cellular phone. Charger 1500B recharges battery 1502 without the need for removing the battery from electronic device 1504. Additionally, during the recharging process the electronic device 1504 can be powered by the charger. The power necessary for recharging is provided by plugging the charger 1500B into a power source such as a wall socket.

In FIG. 15C, the fuel cell battery and charger are incorporated into a single device 1500C and used to power the electronic device 1504. The recharging is done internally by plugging the electronic device into a power source such as a wall socket.

Additional applications for the charger include recharging batteries used for telecommunication devices such as cellular phones, portable electronic devices such as lap tops, digital music players, personal digital assistants, and global positioning systems, backup power supplies, remote sensors, and closed circuit cameras. The charger can be configured for batteries used for any residential, industrial or commercial electronic device. The charger can also be configured to recharge batteries used to power a mechanical engine, such as in an automobile. Battery components can be adjusted so as to provide the required voltage, power, and current handling capabilities for each application. For example, electrical components such resistors, diodes, capacitors, and transistors may be modified to achieve the proper electrical configuration for the desired application.

The electronics and electrical circuitry required for interfacing a fuel cell battery with an electronic device are described in U.S. Pat. No. 7,005,206 and U.S. Patent Application No. 2004175598, which are herby incorporated by reference. Thus, one of ordinary skill in the art could replace the fuel cell battery of the above reference with a battery configured to be recharged by the charger as disclosed in the current application.

Additional applications for the charger include recharging batteries used for transportation, backup power or any other application requiring battery power.

A number of charger configurations have been disclosed for recharging fuel used to generate hydrogen for a hydrogen consuming device. Various modifications of those described may be made without departing from the scope or spirit of the disclosure. Those examples should not be construed as limiting scope of the charge otherwise described above.

1-92. (canceled)

93. A method of recharging an M(BH₄)_{y} fuel in a self-contained system, comprising:
(a) converting the M(BH₄)_{y} fuel to hydrogen and M(BO₂)_{y}, wherein M is a cationic metal ion and y is an integer having the same value as the charge on M;
(b) reacting the M(BO₂)_{y} with a metal and hydrogen to produce the M(BH₄)_{y} fuel and a metal oxide or hydroxide; and
(c) converting the metal oxide or hydroxide back to the corresponding reduced metal; wherein steps (b) and (c) occur within a self-contained system in which no material external to the self-contained system other than electricity and a hydrogen source is required for one or multiple recharging cycles.

94. The method of claim 93, wherein the hydrogen source is water that is converted to hydrogen and oxygen.

95. The method of claim 93, wherein the metal is selected from the group consisting of Al, Na, Mg, and any combination of two or more of the foregoing.

96. The method of claim 93, wherein converting the M(BO₂)_{y} to the M(BH₄)_{y} fuel comprises:
(i) reacting the M(BO₂)_{y} with hydrogen and aluminum to form Al₂O₃ and the M(BH₄)_{y};
(ii) reacting the M(BO₂)_{y} with hydrogen and magnesium to form MgO and the M(BH₄)_{y}; or
(iii) reacting the M(BO₂)_{y} with hydrogen and sodium to form NaOH and the M(BH₄)_{y}.

97. The method of claim 93, wherein converting the metal oxide or hydroxide back to the corresponding reduced metal comprises:
(i) converting Al₂O₃ to aluminum and oxygen;
(ii) combining MgO and hydrogen to form magnesium and water; or
(iii) combining NaOH and hydrogen to form sodium and water.

98. The method of claim 97, wherein the MgO or the NaOH is reacted with HCl to produce a metal chloride and oxygen, and the metal chloride is electrolytically converted to the metal and chlorine.

99. The method of claim 97, wherein the Al₂O₃ is electrolytically converted to the aluminum and oxygen

100. The method of claim 93, wherein the M(BO₂)_{y} is converted to the M(BH₄)_{y} fuel and the metal oxide or hydroxide is converted to the corresponding reduced metal in the same reaction vessel.

101. The method of claim 93, wherein M is selected from the group consisting of Li, Na, K, and Mg.

102. The method of claim 93, wherein the hydrogen is from an electrolytic cell that converts water into hydrogen and oxygen.

103. The method of claim 93, further comprising separating the M(BH₄)_{y} from the metal oxide or hydroxide by removing the M(BH₄)_{y} as a liquid from the solid form of the metal oxide or hydroxide.

104. The method of claim 103, further comprising introducing liquid M(BH₄)_{y} into a cooling liquid to form a slurry containing solid M(BH₄)_{y} particles prior to delivering M(BH₄)_{y} to a fuel cartridge.

105. The method of claim 104, further comprising filtering the slurry to separate the solid M(BH₄)_{y} particles from the cooling liquid.

106. The method to claim 93, further comprising obtaining the M(BO₂)_{y} from a fuel cartridge of a hydrogen consuming device.

107. The method of claim 93, further comprising delivering the M(BH₄)_{y} to a fuel cartridge of a hydrogen consuming device.

108. A method of recharging a metal fuel used to produce hydrogen for a hydrogen consuming device, the method comprising:
(a) reacting a metal oxide or hydroxide with HCl to produce a metal chloride, wherein the metal oxide or hydroxide is a byproduct of the reaction of the metal fuel with H₂O to produce hydrogen for a hydrogen consuming device;
(b) electrolytically converting the metal chloride to the metal and chlorine; and
(c) reacting the chlorine with hydrogen to reform the HCl.

109. The method of claim 108, wherein steps (a) to (c) occur within a self-contained system in which no material external to the self-contained system other than electricity and a hydrogen source is required for one or multiple recharging cycles.

110. The method of claim 108, wherein the metal fuel is (i) a mixture or alloy of Na and Al or (ii) a mixture or alloy of Na and Mg.

111. An apparatus for recharging an M(BH₄)_{y} fuel, the apparatus comprising:
(i) one or more reaction vessel(s) configured for converting M(BO₂)_{y} to the M(BH₄)_{y} fuel, wherein the M(BO₂)_{y} is a byproduct of the reaction of the M(BH₄)_{y} fuel with H₂O to produce hydrogen for a hydrogen consuming device, and wherein M is a cationic metal ion and y is an integer having the same value as the charge on M; and
(ii) a hydrogen supply in fluid communication with one or more of the reaction vessel(s).

112. The apparatus of claim 111, wherein the apparatus is configured to recharge a fuel used by a vehicle.
